(19) United States
(12) Patent Application Publication
(10) Pub. No.: US 2017/0357328 A1
(43) Pub. Date: Dec. 14, 2017

(54) QUICK COMMAND ENTRY FOR WEARABLE DEVICES

(71) Applicant: Empire Technology Development LLC, Wilmington, DE (US)

(72) Inventors: Qi Li, Haidian District, Beijing (CN); Xuefeng SONG, Hebei (CN)

(73) Assignee: Empire Technology Development LLC, Wilmington, DE (US)

(21) Appl. No.: 15/540,055

(22) PCT Filed: Dec. 29, 2014
(86) PCT No.: PCT/CN2014/095263

§ 371 Date: Jun. 27, 2017

(51) Int. Cl. G06F 3/01; G06K 9/78; G06K 9/00; G06F 21/31

(52) U.S. Cl. CPC G06F 3/017; G06K 9/00355; G06K 9/00375; G06K 9/78; G06F 21/316

(57) ABSTRACT

In some examples, a technique of unlocking a wearable device may recognize a pattern on an object and track a path of movement of a visual point within the pattern. The technique may also determine whether the path of movement of the visual point within the pattern approximately matches a predefined path. The technique may further enable one or more functions of a device in response to the path of movement of the visual point approximately matching the predefined path.

### TECHNICAL FIELD

The embodiments described herein pertain generally to wearable devices and, more particularly, to command entry for wearable devices.

### BACKGROUND

Unless otherwise indicated herein, the approaches described in this section are not prior art to the claims in this application and are not admitted to be prior art by inclusion in this section.

Traditional approaches of inputting data and/or commands, e.g., an unlocking command, into computing devices typically employ input from a keyboard or a touch screen. However, for wearable devices such as smart glasses, it may not be practical, convenient or fast to input data or commands into the wearable device using a keyboard or touch screen. For example, it would not be practical or convenient to enter a command to unlock a pair of smart glasses using a keyboard or touch screen.

### SUMMARY

In one example embodiment, a method may include: recognizing a pattern on an object; tracking a path of movement of a visual point within the pattern; determining whether the path of movement of the visual point within the pattern approximately matches a predefined path; and enabling one or more functions of a device in response to the path of movement of the visual point approximately matching the predefined path.

In another embodiment, a non-transitory computer-readable medium, hosted on a computing device/system, may store one or more executable instructions that, when executed, cause one or more processors to perform operations including: recognizing a pattern on an object; tracking a path of movement of a visual point within the pattern; and matching the path of movement of the visual point within the pattern to a predefined path.

In yet another example embodiment, an apparatus may include a recognition device configured to recognize a pattern on an object, an image tracking and capturing device configured to track a path of movement of a visual point with respect to the pattern, and a processor coupled to the recognition device and the image tracking and capturing device. The processor may be configured to perform operations including: determining whether the path of movement of the visual point within the pattern approximately matches a predefined path; and enabling one or more functions of the apparatus in response to the path of movement of the visual point approximately matching the predefined path.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example environment in which a technique of command entry may be implemented, arranged in accordance with at least some embodiments described herein.

FIG. 2 shows an example scenario of command entry for a wearable device in accordance with at least some embodiments described herein.

FIG. 3 shows an example configuration of an apparatus with which a technique of command entry for a wearable device may be implemented, arranged in accordance with at least some embodiments described herein.

FIG. 4 shows an example processing flow with which a technique of command entry for a wearable device may be implemented, arranged in accordance with at least some embodiments described herein.

FIG. 5 shows an example processing flow with which a technique of command entry for a wearable device may be implemented, arranged in accordance with at least some embodiments described herein.

### DETAILED DESCRIPTION

in the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Embodiments of the present disclosure relate to command entry for wearable devices. The proposed technique achieves quick command entry for wearable devices such as smart glasses. Generally, when a wearable or mobile device stops executing any operation for a long period of time, or the user of such device closes the screen of the device, the operating system of the device typically executes a locking operation to lock the device. The locking of the device may include screen locking and shutting down of some applications. If the user desires to continue to use the device, the user would need to execute an unlocking operation.

With embodiments of the present disclosure, to unlock a pair of smart glasses, fingers of one hand of a user may be used to form the shape similar to a nine-grid pattern. A focal point, or visual point, of the smart glasses may move across a number (e.g., three to nine) of the nine grids in a particular sequence as a way to input a command desired by the user, e.g., unlocking the smart glasses. In implementing the proposed technique the user may move both his head and the palm of his hand. The user may thus quickly enter a command into the smart glasses to achieve the desired result, e.g., unlocking the smart glasses.

Accordingly, there are a number of benefits associated with implementation of the proposed technique in wearable devices such as smart glasses, including: sufficient safety, convenience of use for the user, fun and compatibility among different devices. Additionally, the proposed technique saves battery power and enhances security by preventing unauthorized use of the device.

Compared with other command entry methods, the proposed technique has a number of advantageous characteristics. Firstly, it is relatively covert, with high degree of security, where unlocking can be achieved by a small displacement of the user's head or palm such that it is hard to be cracked by others. The proposed technique has higher degree of covertness than methods that require finger movement or winking of an eye. Secondly, either or both of the head and palm of the user can move for command entry with the proposed technique, making it convenient to use by users with various degrees of disability or handicap. Thirdly, the proposed technique is more adapted to the characteristics of smart glasses, and is more convenient and simpler to use. Moreover, the proposed technique can be used in combination with fingerprint identification or palm print identification, thereby enhancing the security.

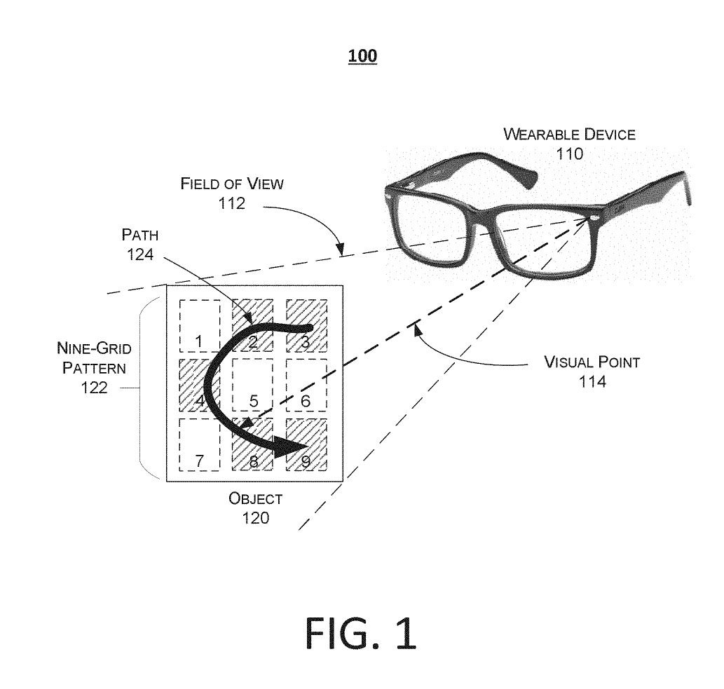

FIG. 1 shows an example environment 100 in which a technique of command entry for a wearable device 110 may be implemented, arranged in accordance with at least some embodiments described herein. Environment 100 includes a wearable device 110 and an object 120. Object 120 may have a pattern thereon. For example, as shown in FIG. 1, object 120 may have a nine-grid pattern 122 thereon. Wearable device 110 has a field of view 112 and is configured to recognize a pattern on an object, e.g., pattern 122 on object 120. Wearable device 110 is also configured to track a path of movement of a visual point with respect to the pattern on the object. For example, as shown in FIG. 1, wearable device 110 may track a path 124 of movement of a visual point 114 with respect to pattern 122 on object 120. Wearable device 110 may include one or more processors which cause wearable device 110 to perform operations described herein.

In some embodiments, object 120 may be a human hand. Alternatively, object 120 may be an object with pattern thereon such as, for example, a floor with tiles, a wall with tiles, a piece of clothing with pattern thereon, a keyboard of a computing device, a piece of paper with a pattern thereon, a cover of a book where the cover has a pattern thereon, etc.

For illustrative purpose, in FIG. 1 wearable device 110 is shown as a pair of smart glasses worn by a user (not shown). Those of ordinary skill in the art would appreciate that, in various embodiments, the proposed technique may be implemented in other wearable or mobile devices such as, for example, mobile phone, tablet computer and any future wearable devices yet to be introduced to the market.

In the example illustrated in FIG. 1, pattern 122, being a nine-grid pattern, includes nine grids or boxes numbered from 1 through 9. As an example, a predefined path that approximately resembles a path connecting grid 3, grind 2, grind 4, grind 8 and grind 9, in that order, is construed to be a command to enable one or more functions of wearable device 110, including unlocking wearable device 110. Thus, when path 124 of the visual point 114 of wearable device 110 (e.g., smart glasses) moves across pattern 122 in a fashion such that path 124 approximately matches the predetermined path (in the order of grid 3, grid 2, grid 4, grid 8 and grid 9 in a nine-grid pattern), one or more functions of wearable device 110 become enabled or activated. In some embodiments, the enabled or activated one or more functions may include unlocking of the wearable device 110.

Traditional methods of unlocking a mobile device such as mobile phone and tablet computer typically require the user to unlock the device by sliding a finger across the screen, by circle dragging, by sliding a finger through a nine-grid pattern, or by pushing a button. However, such methods are not suitable for future wearable devices including smart glasses. In contrast, the proposed technique utilizes any suitable object with a pattern thereon to achieve the purpose of command entry, e.g., to unlock the wearable device.

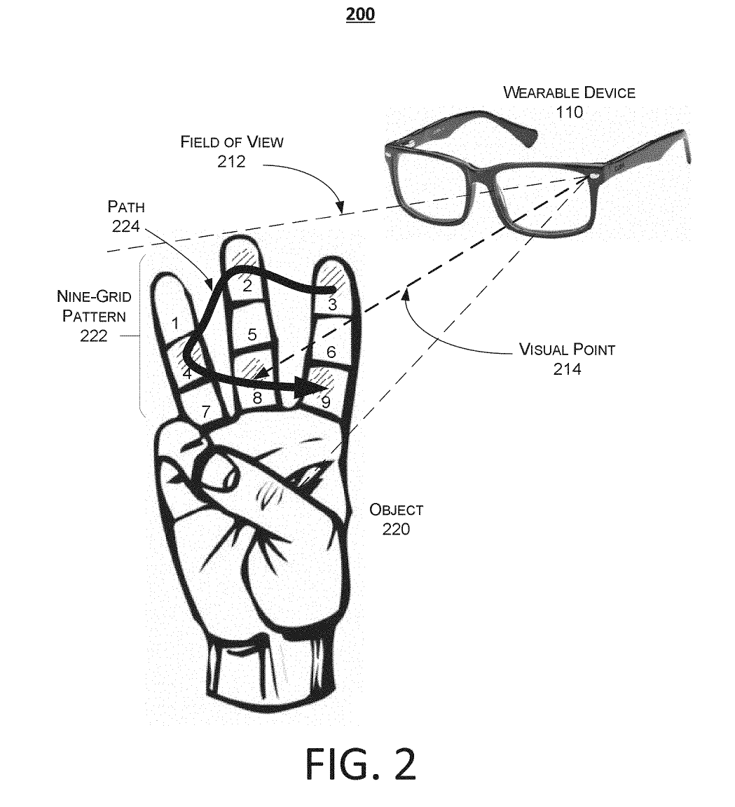

FIG. 2 shows an example scenario 200 of command entry for wearable device 110 in accordance with at least some embodiments described herein. Example scenario 200 includes wearable device 110 and object 220, which is the palm of a hand of a user of wearable device 110. The object 220 has a pattern 222 thereon. Due to existence of joints in fingers, a human hand can naturally be divided into nine grid areas as a nine-grid pattern. For example, nine-grid pattern is based on three sections of an index finger of the human hand as object 220, three sections of a middle finger of the human hand as object 220, and three sections of a ring finger of the human hand as object 220.

Wearable device 110, e.g., a pair of smart glasses, has a field of view 212 and is configured to perform a number of operations. These operations may include: recognizing the pattern 222 (e.g., nine-grid pattern) on the human hand as object 220, tracking a path 224 of movement of a visual point 214 within the pattern 222, determining whether the path 224 of movement of the visual point 214 within the pattern 222 approximately matches a predefined path, and enabling one or more functions of wearable device 110 in response to a positive determination (that the path 224 of movement of the visual point 214 approximately matching the predefined path). The one or more enabled functions may include unlocking the wearable device 110. When the wearable device 110 is locked, one or more features of the wearable device 110 become disabled or otherwise deactivated; and when the wearable device 110 is unlocked, those one or more features of the wearable device 110 become enabled or otherwise activated. One of ordinary skill in the art would appreciate that the aforementioned capability may be implemented in portable devices such as smart glasses, mobile phones, tablet computers and the like.

In some embodiments, in tracking the path 224 of movement of the visual point 214 within the pattern 222, wearable device 110 may connect a plurality of points within the pattern 222, where each of the plurality of points may include a respective grid in the pattern 222 within which the visual point 214 moves a distance no less than a threshold length and for a duration no less than a threshold time. For example, pattern 222 may be a nine-grid pattern as shown in FIG. 2. Each of the plurality of points may include a respective grid in the nine-grid pattern within which the visual point 214 moves a distance no less than a threshold length and for a duration no less than a threshold time.

In some embodiments, a quantity of the plurality of points is more than a threshold quantity and less than or equal to a quantity of grids in the pattern 222. For example, when the pattern 222 is a nine-grid pattern with nine grids, there may be a minimum of three points and up to nine points in pattern 222.

In some embodiments, the visual point 214 may include a center point of an image of an image capturing device of wearable device 110 or a focal point of light projected by a light emitting device of wearable device 110. For example, visual point 214 may be a center point of an image captured by a camera of a pair of smart glasses as wearable device 110.

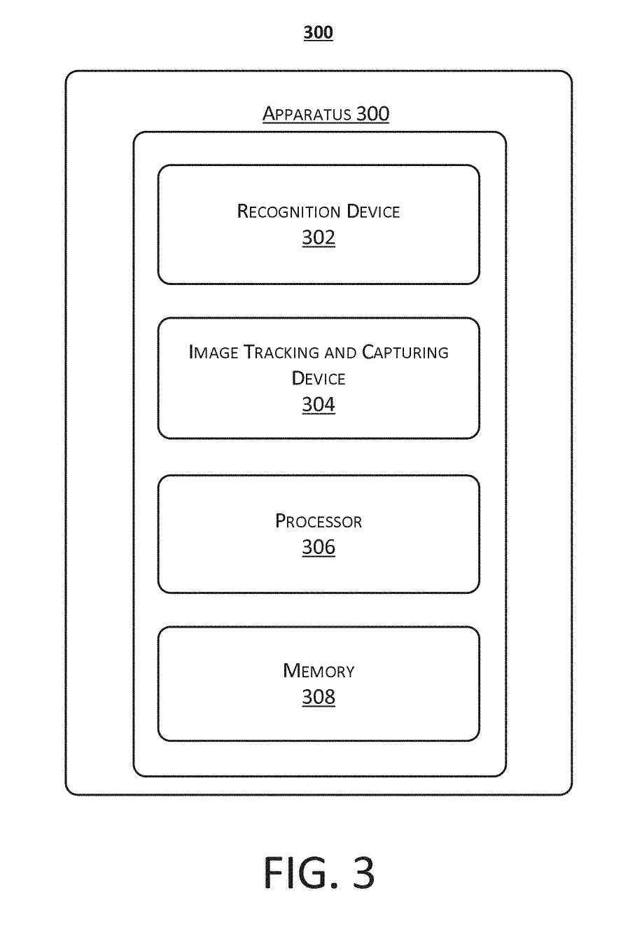

FIG. 3 shows an example configuration of an apparatus 300 with which a technique of command entry may be implemented, arranged in accordance with at least some embodiments described herein. In some embodiments, apparatus 300 may be implemented as wearable device 110. Alternatively, apparatus 300 may be implemented as a device external to and separate from wearable device 110, and communicates with wearable device 110 by any suitable wired and/or wireless communication means.

As depicted in FIG. 3, apparatus 300 may be configured to include various components including, but not limited to, a recognition device 302, an image tracking and capturing device 304, a processor 306 and memory 308. Recognition device 302 may be configured to recognize a pattern on an object. For example, recognition device 302 may recognize the contour, or shape, of each finger of a human hand (e.g., object 220). In some embodiments, a color recognition technique may be utilized to discern or otherwise recognize the contour of each finger of the human hand, as the color of the flesh of the fingers is usually distinct from the color of the surrounding environment to show a certain regular pattern of fingers of a human hand. Recognition device 302 may regard the shape of an object, e.g., object 120 and object 110, as a closed curve of a plane in a three-dimensional spatial coordinate system. Accordingly, recognition device 302 may use a function to describe features of the shape and then perform an internal operation, e.g., discrete Fourier transformation.

In some embodiments, as discussed above, the object may be a human hand. Accordingly, the pattern may include a nine-grid pattern defined by three sections of an index finger of the human hand, three sections of a middle finger of the human hand, and three sections of a ring finger of the human hand.

Image tracking and capturing device 304 may be configured to track a path of movement of a visual point with respect to the pattern. For example, image tracking and capturing device 304 may project an optical point or a similar image central point at the center of image as viewed by apparatus 300. When the central point is in a certain grid of a pattern, e.g., nine-grid pattern, image tracking and capturing device 304 may automatically collect and record associated data. In some embodiments, to minimize misjudgment, image tracking and capturing device 304 may specify a scanning length and/or a stay time. For example, the scanning length in each grid of a nine-grid pattern may be no less than a threshold length, e.g., 5 mm. Alternatively or additionally, the scanning time in each grid of the nine-grid pattern may be no less than a threshold time, e.g., 50 ms. Accordingly, any scanning length or scanning time less than the respective threshold may be regarded as invalid scanning and not used.

In some embodiments, the visual point may be a center point of an image of image tracking and capturing device 304. Alternatively, the visual point may be a focal point of light projected by image tracking and capturing device 304 or a light emitting device of apparatus 300, which may or may not be an integral part of image tracking and capturing device 304.

Processor 306 may be coupled to recognition device 302 and image tracking and capturing device 304. Processor 306 may be configured to perform operations including: determining whether the path of movement of the visual point within the pattern approximately matches a predefined path and enabling one or more functions of apparatus 300 in response to a positive determination that the path of movement of the visual point approximately matching the predefined path. In some embodiments, after collecting data associated with the path of movement of the visual point within the pattern, processor 306 may compare the path with previously-stored commands, e.g., predefined paths of movement or combination of numbers, to determine whether the path of movement of the visual point approximately matches any of the previously-stored commands. For example, a command for unlocking the apparatus 300 may be “32489”. If the path of movement of the visual point (e.g., path 124 of movement of visual point 114 in FIG. 1 and/or path 224 of movement of visual point 214 in FIG. 2) results in sufficient scanning length and scanning time in grids 3, 2, 4, 8 and 9, in that order, then processor 306 may determine that an unlocking command is entered by the user and hence proceeds to unlock apparatus 300 by enabling or otherwise activating one or more features or functions of apparatus 300.

In some embodiments, in tracking the path of movement of the visual point within the pattern, processor 306 may connect a plurality of points within the pattern. For example, the pattern may be a nine-grid pattern as shown in FIG. 1 and FIG. 2. Each of the plurality of points may include a respective grid in the nine-grid pattern within which the visual point moves a distance no less than a threshold length and for a duration no less than a threshold time.

In some embodiments, a quantity of the plurality of points is more than a threshold quantity and less than or equal to a quantity of grids in the pattern. For example, when the pattern is a nine-grid pattern with nine grids, there may be a minimum of three points and up to nine points in pattern.

Memory 308 may be coupled to processor 306 and may be configured to store data (e.g., data from image tracking and capturing device 304 and processor 306) as well as instructions executable by processor 306. For example, processor 306 may access one or more instructions stored in memory 308 to perform at least the operations described above. Memory 308 is non-transitory computer-readable storage medium. For example, memory 308 may be in the form of, but is not limited to, random-access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other medium which may be used to store the desired information/data and which may be accessed by processor 306.

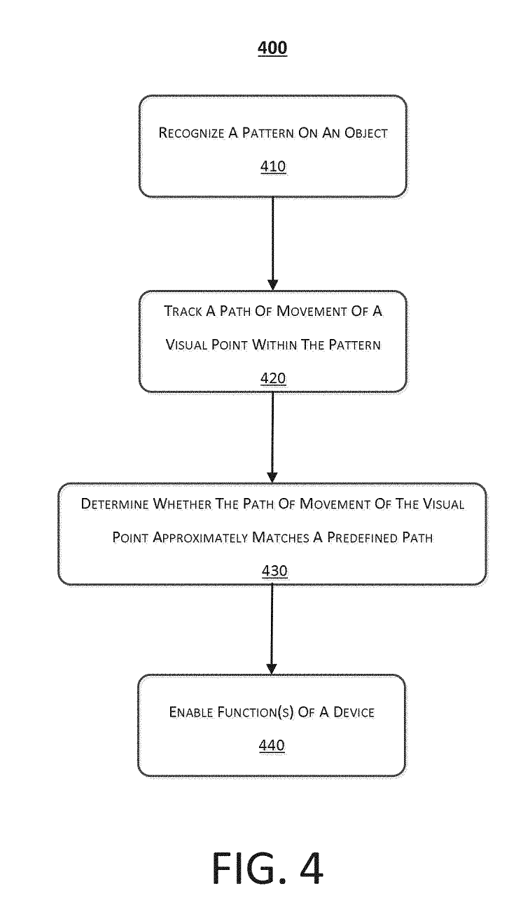

FIG. 4 shows an example processing flow 400 with which a technique of command entry for a wearable device may be implemented, arranged in accordance with at least some embodiments described herein. Processing flow 400 may be implemented by wearable device 110 and/or apparatus 300. Further, processing flow 400 may include one or more operations, actions, or functions depicted by one or more blocks 410, 420, 430 and 440. Although illustrated as discrete blocks, various blocks may be divided into additional blocks, combined into fewer blocks, or eliminated, depending on the desired implementation. For illustrative purpose, processing flow 400 is described in the context of an implementation by one or more processors of wearable device 110, which may be in the form of a pair of smart glasses. Processing flow 400 may begin at block 410.

Block 410 (Recognize A Pattern On An Object) may refer to the one or more processors of wearable device 110 recognizing a pattern on an object. For example, the one or more processors of wearable device 110 may recognize a pattern 122, a nine-grid pattern, defined by the index finger, the middle finger and the ring finger of a user's hand, e.g., object 120.

Block 420 (Track A Path Of Movement Of A Visual Point Within The Pattern) may refer to the one or more processors of wearable device 110 tracking a path of movement of a visual point within the pattern. For example, the one or more processors of wearable device 110 may track path 124 of movement of visual point 114 within the pattern 122.

Block 430 (Determine Whether The Path Of Movement Of The Visual Point Approximately Matches A Predefined Path) may refer to the one or more processors of wearable device 110 determining whether the path of movement of the visual point within the pattern approximately matches a predefined path. For example, the one or more processors of wearable device 110 may determine whether the path 124 of movement of the visual point 114 within the pattern 122 approximately matches a predefined path.

Block 440 (Enable Function(s) Of A Device) may refer to the one or more processors of wearable device 110 enabling one or more functions of a device in response to the path of movement of the visual point approximately matching the predefined path. For example, in response to a positive determination that the path 124 of movement of the visual point 114 approximately matching the predefined path, the one or more processors of wearable device 110 may enable one or more functions of a device, including unlocking wearable device 110.

In some embodiments, the object may be a human hand.

In some embodiments, in performing recognizing, the one or more processors of wearable device 110 may define a nine-grid pattern based on three sections of an index finger of the human hand, three sections of a middle finger of the human hand, and three sections of a ring finger of the human hand.

In some embodiments, in tracking the path of movement of the visual point within the pattern, the one or more processors of wearable device 110 may connect a plurality of points within the pattern. Each of the plurality of points may include a respective grid in the pattern within which the visual point moves a distance no less than a threshold length and for a duration no less than a threshold time.

In some embodiments, each of the plurality of points may include a respective grid in a nine-grid pattern within which the visual point moves a distance no less than a threshold length and for a duration no less than a threshold time.

In some embodiments, a quantity of the plurality of points may be more than a threshold quantity and less than or equal to a quantity of grids in the pattern.

In some embodiments, the visual point may include a center point of an image of an image capturing device or a focal point of light projected by a light emitting device.

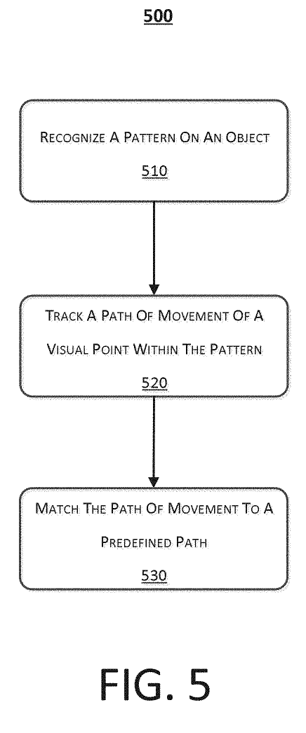

FIG. 5 shows an example processing flow 500 with which a technique of command entry for a wearable device may be implemented, arranged in accordance with at least some embodiments described herein. Processing flow 500 may be implemented by wearable device 110 and/or apparatus 300. Further, processing flow 500 may include one or more operations, actions, or functions depicted by one or more blocks 510, 520 and 530. Although illustrated as discrete blocks, various blocks may be divided into additional blocks, combined into fewer blocks, or eliminated, depending on the desired implementation. For illustrative purpose, processing flow 500 is described in the context of an implementation by one or more processors of wearable device 110, which may be in the form of a pair of smart glasses. Processing flow 500 may begin at block 510.

Block 510 (Recognize A Pattern On An Object) may refer to the one or more processors of wearable device 110 recognizing a pattern on an object. For example, the one or more processors of wearable device 110 may recognize a pattern 122, a nine-grid pattern, defined by the index finger, the middle finger and the ring finger of a user's hand, e.g., object 120.

Block 520 (Track A Path Of Movement Of A Visual Point Within The Pattern) may refer to the one or more processors of wearable device 110 tracking a path of movement of a visual point within the pattern. For example, the one or more processors of wearable device 110 may track path 124 of movement of visual point 114 within the pattern 122.

Block 530 (Match The Path Of Movement To A Predefined Path) may refer to the one or more processors of wearable device 110 matching the path of movement of the visual point within the pattern to a predefined path. For example, the one or more processors of wearable device 110 may match the path 124 of movement of the visual point 114 within the pattern 122 to a predefined path by determining whether the path 124 of movement of the visual point 114 within the pattern 122 approximately matches a predefined path.

In some embodiments, the object may be a human hand.

In some embodiments, the operation of recognizing may include defining a nine-grid pattern based on three sections of an index finger of the human hand, three sections of a middle finger of the human hand, and three sections of a ring finger of the human hand.

In some embodiments, the operation of tracking the path of movement of the visual point within the pattern may include connecting a plurality of points within the pattern. Each of the plurality of points may include a respective grid in the pattern within which the visual point moves a distance no less than a threshold length and for a duration no less than a threshold time.

In some embodiments, a quantity of the plurality of points may be more than a threshold quantity and less than or equal to a quantity of grids in the pattern.

In some embodiments, the visual point may include a center point of an image of an image capturing device or a focal point of light projected by a light emitting device.

In some embodiments, the operations may also include unlocking a device in response to the path of movement of the visual point approximately matching the predefined path. For example, processing flow 500 may further unlock wearable device 110 in response to a positive determination that the path 124 of movement of the visual point 114 approximately matching the predetermined path.

In some examples, a method may comprise: recognizing, by one or more processors, a pattern on an object; tracking, by the one or more processors, a path of movement of a visual point within the pattern; determining, by the one or more processors, whether the path of movement of the visual point within the pattern approximately matches a predefined path; and enabling, by the one or more processors, one or more functions of a device in response to the path of movement of the visual point approximately matching the predefined path. In some examples, the method may be a method of user interface with an electronic device, such as a method of providing alphanumeric data, e.g., numeric data, to an electronic device. For example, a user of apparatus 300, which may be implemented as wearable device 110, in which the one or more processors, e.g., processor 306, are implemented may be able to use apparatus 300 to look at a number of grids, squares or blocks of a pattern, e.g., alphanumeric keys of a keyboard or keypad similar to object 120 shown in FIG. 1, in a sequence. The sequential movement of the visual point through the grids, squares or blocks of the pattern may be used as a command to execute one or more operations by apparatus 300 or another computing device. Alternatively, sequential movement of the visual point through the grids, squares or blocks of the pattern may be used as a key or password to unlock apparatus 300 or another computing device. In the example shown in FIG. 1, the sequence of movement of the visual point through the grids, squares or blocks of the nine-grid pattern 122, which may be nine numeric keys on a keyboard or keypad, results in a string of alphanumeric characters or values “32489”, which may be interpreted by apparatus 300 or another computing device as a command, a key or a password. The resultant string of alphanumeric characters or values may or may not match any command, key or password. In the event that the resultant string of alphanumeric characters or values does not match any command, key or password, then no action may occur as a result.

In some examples, the object on which the pattern is located may comprise a human hand. In some examples, a human hand may be recognized by image recognition software executed by one or more processors, for example by one or more processors in an electronic device such as wearable device 110 and apparatus 300. The human hand may then be partitioned into a plurality of portions, for example by the image recognition software, such as by using skin creases and/or joints as boundaries between at least two portions. A hand may be partitioned into a plurality of portions, for example with each portion associated with an alphanumeric character or operator. In the example shown in FIG. 2, the human hand as object 220 is partitioned into nine portions or grids as a nine-grid pattern, with each portion or grid associated with a respective number, e.g., numbers 1-9.

In some examples, the object on which the pattern is located may comprise a body part (such as a hand, foot, animal paw, or other body part), a hand-drawn sketch on paper, a printed sheet, or any object whose image may be divided into portions. In some examples, the object on which the pattern is located may comprise a clothing item or portion thereof. For example, an image of plaid or otherwise checked clothing may readily be divided up into portions and the portions used for data entry. In some examples, a glove may have thereon a pattern which divides the glove image into portions.

In some examples, the operation of recognizing may comprise defining a pattern that comprises a nine-grid pattern, based on three sections of three fingers of a hand, such as three adjacent fingers, e.g., three sections of an index finger of the human hand, three sections of a middle finger of the human hand, and three sections of a ring finger of the human hand. For example, a pattern may include portions of the hand, which may be defined by a portion of the outline of the hand (such as a periphery of a finger) and one or more skin creases, for example skin creases associated with finger joints. In some examples, a pattern may include additional portions to the nine-grid pattern. In some examples, a hand may be partitioned into, for example, at least 9 or 10 portions, associated with the digits 1-9 and 0-9 respectively. In some examples, additional portions may be identified and associated with numeric characters (such as 1-9 or 0-9), alphabetic characters, non-alphanumeric characters, numeric operators (such as plus, minus, divide, multiply, equals, and the like), and/or other operators (such as enter, clear, undo, re-do, cancel, image save, self-destruct, and the like). In some examples, one or more portions may be associated with other data, such as aural sense data (e.g. tone pitch, chord data, acoustic modulation, envelope, and the like), visual sense data (such as color), haptic data (such as vibration frequency), and the like.

In some examples, the electronic device, e.g., wearable device 110 or apparatus 300, may provide an augmented reality view of the object. For example, the electronic device may include a display portion through which an object may be viewed, for example in an augmented reality view with the augmentation provided by the display portion under the control of one or more processors. In some examples, a pattern may be shown as visually perceivable lines that augment a view of the object. In some examples, data labels may be shown in an augmented reality view, such as representing data associated with respective portions. For example, each portion may be shown as being associated with an alphanumeric value (such as a numeric value), an operator, a non-alphanumeric character, and the like.

In some examples, a method may comprise tracking a path of movement of a visual point within the pattern and connecting a plurality of points within the pattern. Each of the plurality of points may comprise a respective grid in the pattern within which the visual point moves a distance no less than a threshold length, e.g., 1 centimeter, 1 inch or any other suitable length, and for a duration no less than a threshold time, e.g., 1 second, 2 seconds or 5 seconds. In some examples, a pattern may comprise a nine-grid pattern, and each of the plurality of portions, or locations therein, may comprise a respective grid in the nine-grid pattern within which the visual point moves a distance no less than a threshold length, e.g., 1 centimeter, 1 inch or any other suitable length, and for a duration no less than a threshold time, e.g., 1 second, 2 seconds, 5 seconds or any other suitable time.

In some examples, a visual point may comprise a center point of an image of an image capturing device, a point of light projected by a light emitting device, a user focus location determined by an eye tracker, or other representation. In some examples, a visual point may be a tracked focal point of a user viewing the object. In some examples, a visual point may be associated with a finger, a writing implement, a stylus, an elongated member, or other item such as, for example, the end or tip thereof. For example, a visual point may be associated with a distal end portion of a finger such as a fingertip, a tapered end portion of a stylus writing implement, or an end portion or tip of another elongated element. In some examples, if a visual point is determined to be located within a portion of a pattern for greater than a threshold time, associated data (such as a numerical value, operator, other alphanumeric character, or other characters such as kanji and the like, or other data) is entered into an electronic device, e.g., wearable device 110 or apparatus 300. In some examples, the visual point need not be tracked, and data entry may be determined from the location and duration of a visual point within a portion of the pattern. In some examples, selection of a portion of a pattern may be indicated in an augmented reality view, such as by a color change, audible signal, and the like. In some examples, a visual point may be indicated by a personal adornment, such as a fingernail color, thimble, or other end-of-finger modification.

In some examples, a method such as described herein may be used to provide data to an electronic device, such as a mobile electronic device, for example to provide an access code, personal identification number, password, or other data. In some examples, provision of data may allow unlocking of an electronic device, verification of a transaction, confirmation of a financial or other transfer, or access to a website, account, and the like (for example after a positive comparison with previously established data). In some examples, a method may be a method of unlocking a wearable device, such as an electronic device with an eyeglass interface, or may be used to provide data to the electronic device for any purpose, for example for provision of a security code (such as a personal identification number), arithmetic calculation (e.g., using the data input as that of an electronic calculator), ordering, and the like. Examples may be used for data input into any form of wearable electronic device, for example using an eyeglass interface. Examples may include a method for quickly unlocking an electronic device comprising an eyeglass interface. In some examples, fingers of one hand may provide a pattern comprising a pattern similar to a nine-grid square, and a visual point may move between portions in a particular sequence to provide the desired data. In some examples, the visual point may be a tracked focus point of one or more eyes of the user. In some examples, an elongated member, such as a finger, stylus, and the like) may be used to provide an indication of intended data input.

In some examples, a human hand may be divided into a pattern including portions that may be defined by the joints and/or other skin creases of the hand. The portions may be recognized relative to a hand by an electronic device with image capture and image processing capabilities, such as a mobile electronic device comprising wearable glasses, for example comprising an image sensor. An example data entry system for an electronic device may comprise a hand and/or finger recognition system, an image tracking and capturing system, and one or more processors. In some examples, a finger recognition system may recognize the edge of each finger, for example using color recognition, for example from a contrast between a hand color and a background color. In some examples, an object may be analyzed as existing within closed curve on a plane in a three-dimensional spatial coordinate system, or within certain angular coordinates within the field of view. The object, such as a hand or portion thereof, may be tracked within the environment and the identified pattern moved within a visual field in a corresponding manner. In some examples, a human hand model may be used, including finger motions such as bending and unbending, which may allow improved accuracy of data input.

In some examples, a user may perceive a perceptible mark (an example of a visual point) in the visual field viewed through the eyeglass display. The visual point may be provided by augmented reality, a projected light beam, or otherwise. The user may align the visual point with selected portions of the identified pattern for data entry into an electronic device. In some examples, the visual point may be tracked when it is located within the identified pattern. In some examples, the visual point may be required to remain within a selected portion for a predetermined time for data entry of the associated data to be achieved. In some examples, an invalid entry may be indicated if a total data entry time (or path length of the visual point) exceeds a predetermined time or path length, respectively.

The foregoing detailed description has set forth various embodiments of the devices and/or processes for device configuration 300 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium, e.g., a fiber optic cable, a waveguide, a wired communications link, a wireless communication link, etc.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. it will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method, comprising:
recognizing, by one or more processors, a pattern on an object;
tracking, by the one or more processors, a path of movement of a visual point within the pattern;
determining, by the one or more processors, whether the path of movement of the visual point within the pattern approximately matches a particular path; and
enabling, by the one or more processors, one or more functions of a device in response to the determination that the path of movement of the visual point approximately matches the particular path.

2. The method of claim 1, wherein the object comprises a human hand.

3. The method of claim 2, wherein the recognizing the pattern comprises defining a nine-grid pattern based on three sections of an index finger of the human hand, three sections of a middle finger of the human hand, and three sections of a ring finger of the human hand.

4. The method of claim 1, wherein the tracking the path of movement of the visual point within the pattern comprises connecting a plurality of points within the pattern, and wherein each of the plurality of points comprises a respective grid in the pattern within which the visual point moves a distance no less than a threshold length and for a duration no less than a threshold time.

5. The method of claim 4, wherein the pattern comprises a nine-grid pattern, and wherein each of the plurality of points comprises a respective grid in the nine-grid pattern within which the visual point moves a distance no less than a threshold length and for a duration no less than a threshold time.

6. The method of claim 4, wherein a quantity of the plurality of points is more than a threshold quantity and less than or equal to a quantity of grids in the pattern.

7. The method of claim 1, wherein the visual point comprises a center point of an image of an image capturing device or a focal point of light projected by a light emitting device.

8. A computer-readable storage medium having stored thereon computer-executable instructions executable by one or more processors to perform operations comprising:
recognizing a pattern on an object;
tracking a path of movement of a visual point within the pattern; and
matching the path of movement of the visual point within the pattern to a particular path.

9. The computer-readable storage medium of claim 8, wherein the object comprises a human hand.

10. The computer-readable storage medium of claim 9, wherein the recognizing the pattern comprises defining a nine-grid pattern based on three sections of an index finger of the human hand, three sections of a middle finger of the human hand, and three sections of a ring finger of the human hand.

11. The computer-readable storage medium of claim 8, wherein the tracking the path of movement of the visual point within the pattern comprises connecting a plurality of points within the pattern, and wherein each of the plurality of points comprises a respective grid in the pattern within which the visual point moves a distance no less than a threshold length and for a duration no less than a threshold time.

12. The computer-readable storage medium of claim 11, wherein a quantity of the plurality of points is more than a threshold quantity and less than or equal to a quantity of grids in the pattern.

13. The computer-readable storage medium of claim 8, wherein the visual point comprises a center point of an image of an image capturing device or a focal point of light projected by a light emitting device.

14. The computer-readable storage medium of claim 8, wherein the operations further comprise:
unlocking a device in response to the path of movement of the visual point approximately matching the particular path.

15. An apparatus, comprising:
a recognition device configured to recognize a pattern on an object;
an image tracking and capturing device configured to track a path of movement of a visual point within the pattern; and
a processor coupled to the recognition device and the image tracking and capturing device, wherein the processor is configured to perform operations to:
determine whether the path of movement of the visual point within the pattern approximately matches a particular path; and
enable one or more functions of the apparatus in response to the determination that the path of movement of the visual point approximately matches the particular path.

16. The apparatus of claim 15, wherein the object comprises a human hand.

17. The apparatus of claim 16, wherein the pattern comprises a nine-grid pattern defined by three sections of an index finger of the human hand, three sections of a middle finger of the human hand, and three sections of a ring finger of the human hand.

18. The apparatus of claim 15, wherein, to track the path of movement of the visual point within the pattern, the processor is configured to perform operations to connect a plurality of points within the pattern, and wherein each of the plurality of points comprises a respective grid in the pattern within which the visual point moves a distance no less than a threshold length and for a duration no less than a threshold time.

19. The apparatus of claim 18, wherein a quantity of the plurality of points is more than a threshold quantity and less than or equal to a quantity of grids in the pattern.

20. The apparatus of claim 15, wherein the visual point comprises one of: a center point of an image of the image tracking and capturing device, a focal point of light projected by the image tracking and capturing device or a focal point of light projected by a light emitting device.
